(19) United States
(12) Patent Application Publication
(10) Pub. No.: US 2026/0141814 A1
(43) Pub. Date: May 21, 2026

(54) SYSTEMS AND METHODS FOR MANAGING AN UNMANNED AERIAL VEHICLE (UAV) PLATOON

(71) Applicant: Toyota Motor Engineering & Manufacturing North America, Inc., Plano, TX (US)

(72) Inventors: Rohit Gupta, Santa Clara, CA (US); Ahmadreza Moradipari, Mountain View, CA (US); Sergei S. Avedisov, Redwood City, CA (US); Takayuki Shimizu, Santa Clara, CA (US); Onur Altintas, Sunnyvale, CA (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/950,478

(22) Filed: Nov. 18, 2024

(51) Int. Cl. G08G 5/57; G08G 5/26; G08G 5/56; G08G 5/72

(52) U.S. Cl. CPC G08G 5/57; G08G 5/26; G08G 5/56; G08G 5/723

(57) ABSTRACT

Systems, methods, and other embodiments described herein relate to forming and managing a platoon or convoy of unmanned aerial vehicles (UAVs). In one embodiment, a method includes receiving, from a plurality of UAVs. The intent messages indicate an air corridor and planned path for a respective UAV. The method also includes grouping, based on the air corridor and planned path in multiple intent messages, a set of UAVs into a platoon and generating a coordinated flight path and coordinated flight parameters for the platoon. The method also includes flying the set of UAVs based on the coordinated flight path and the coordinated flight parameters.

### TECHNICAL FIELD

The subject matter described herein relates, in general, to unmanned aerial vehicles (UAVs) and, more particularly, to forming and managing a platoon of UAVs.

### BACKGROUND

An unmanned aerial vehicle (UAV) is an aircraft that does not include an onboard pilot. For example, the UAV may be autonomously operated by a computer system with little to no input from a ground-based pilot. A UAV may be semi-autonomous, meaning that certain flight operations from a ground-based pilot are supplemented by autonomous actions of an autonomous flight module. In either case, a UAV is an aircraft in which a pilot is not physically on or in the vehicle. Such aircraft may include passengers. However, in a UAV, such passengers are not piloting the aircraft. UAVs may take various forms, including drones, vertical take-off and landing (VTOL) aircraft, and electric vertical take-off and landing (eVTOL) aircraft.

UAVs are becoming more widely used in society. As a particular example, some organizations are experimenting with unmanned aerial package delivery vehicles. As another example, like driverless automobiles, autonomous UAVs may transport passengers from one location to another. In the not-too-distant future, UAVs may fill the skies over major metropolitan areas.

### SUMMARY

In one embodiment, example systems and methods relate to a manner of improving UAV flight by grouping multiple UAVs into a platoon.

In one embodiment, a UAV platoon system for forming and managing a platoon of UAVs is disclosed. The UAV platoon system includes a processor and a memory communicably coupled to the processor. The memory stores machine-readable instructions that, when executed by the processor, cause the processor to receive, from a plurality of UAVs, intent messages comprising an air corridor and planned path for a respective UAV. The machine-readable instructions also include instructions to 1) group, based on the air corridor and planned path in multiple intent messages, a set of UAVs into a platoon, and 2) generate a coordinated flight path and coordinated flight parameters for the platoon. The machine-readable instructions also include instructions to fly the set of UAVs based on the coordinated flight path and the coordinated flight parameters.

In one embodiment, a non-transitory computer-readable medium for forming and managing a platoon of UAVs and including instructions that, when executed by one or more processors, cause the one or more processors to perform one or more functions is disclosed. The instructions include instructions to receive, from a plurality of UAVs, intent messages comprising an air corridor and planned path for a respective UAV. The instructions also include instructions to 1) group, based on the air corridor and planned path in multiple intent messages, a set of UAVs into a platoon and 2) generate a coordinated flight path and coordinated flight parameters for the platoon. The instructions also include instructions to fly the set of UAVs based on the coordinated flight path and the coordinated flight parameters.

In one embodiment, a method for forming and managing a platoon of UAVs is disclosed. In one embodiment, the method includes receiving, from a plurality of UAVs, intent messages comprising an air corridor and planned path for a respective UAV. The method also includes 1) grouping, based on the air corridor and planned path in multiple intent messages, a set of UAVs into a platoon and 2) generating a coordinated flight path and coordinated flight parameters for the platoon. The method also includes flying the set of UAVs based on the coordinated flight path and the coordinated flight parameters.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a UAV within which systems and methods disclosed herein may be implemented.

FIG. 2 illustrates one embodiment of a UAV platoon system that is associated with forming and managing a UAV platoon.

FIG. 3 illustrates one embodiment of the UAV platoon system of FIG. 2 in a cloud-computing environment.

FIG. 4 illustrates one embodiment of the UAV platoon system of FIG. 2 in a peer-to-peer computing environment.

FIG. 5 illustrates the formation and management of a UAV platoon.

FIG. 6 illustrates a flowchart for one embodiment of a method that is associated with forming and managing a UAV platoon.

FIG. 7 illustrates a flowchart for one embodiment of a method that is associated with forming and managing a UAV platoon.

### DETAILED DESCRIPTION

Systems, methods, and other embodiments associated with improving UAV control and utilization are disclosed herein. As previously described, the safe and responsible implementation of UAVs introduces exciting and innovative possibilities. For example, the sophistication of UAVs may lead to UAVs populating the airspace, providing an additional means of connecting people in different geographic regions. For example, one can imagine unmanned eVTOLs flying through the skies of a large metropolitan area, transporting products and people across a large and otherwise difficult-to-navigate region, all without relying on a complex and potentially densely populated network of surface streets.

However, as the presence and usage of UAVs are relatively new, certain issues relating to their safe and reliable use should be addressed. For example, as the number of UAVs rises, so does the propensity for collisions between UAVs. Moreover, when used in urban environments, UAVs are at a heightened risk for collision with static objects such as buildings and infrastructure and dynamic objects such as other aircraft, ground vehicles, and pedestrians. Accordingly, the present specification aims to increase the safety and efficiency of eVTOLs, VTOLs, drones, and other UAVs to promote a more widespread implementation of their capabilities.

Specifically, the present specification describes a system that forms UAVs into convoys/platoons that travel in a coordinated fashion. Specifically, the UAVs send intent messages either to a remote server or another UAV in a peer-to-peer system. Based on these intent messages, the UAVs themselves or the remote server groups UAVs into platoons that travel in a coordinated fashion, for example along a shared flight path in a particular flight formation.

The intent message includes different content that may be used to group the UAVs. For example, the intent messages may indicate a projected flight path for the UAV, an identifier of the air corridor in which the UAV is flying, wind/air currents experienced by the UAV, and data indicating whether the UAV is connected to an air traffic controller. In the example where the platoons are formed in a peer-to-peer network, the intent messages between UAVs offload the connection from a ground air traffic controller in case of loss of communication. In some examples, in addition to intent messages, the system may group UAVs based on additional information, such as information from an air traffic controller and/or weather data.

Following grouping, each of the UAVs is flown or controlled in a way that exhibits coordinated flying. For example, the UAVs may be arranged in a leader/follower arrangement where trailing UAVs follow the path of a lead UAV.

In this way, the disclosed systems, methods, and other embodiments improve UAV operation by increasing the efficiency, cost savings, and safety of UAV operation. That is, platooning can increase the efficiency of UAVs by reducing air resistance, similar to how birds fly in a V-formation. For example, a lead UAV may take on a majority of the air resistance, thus allowing the following UAVs to consume less energy. This could lead to energy savings and increased range. In other words, UAVs flying in a platoon may potentially reduce operational costs.

Moreover, platooned flights may reduce air traffic congestion and, if desired, increase the air traffic capacity without compromising the safety of UAVs, freight, and/or passengers. Still further, platooning can potentially increase safety by ensuring that UAVs maintain a safe and consistent distance from each other, reducing the risk of mid-air collisions.

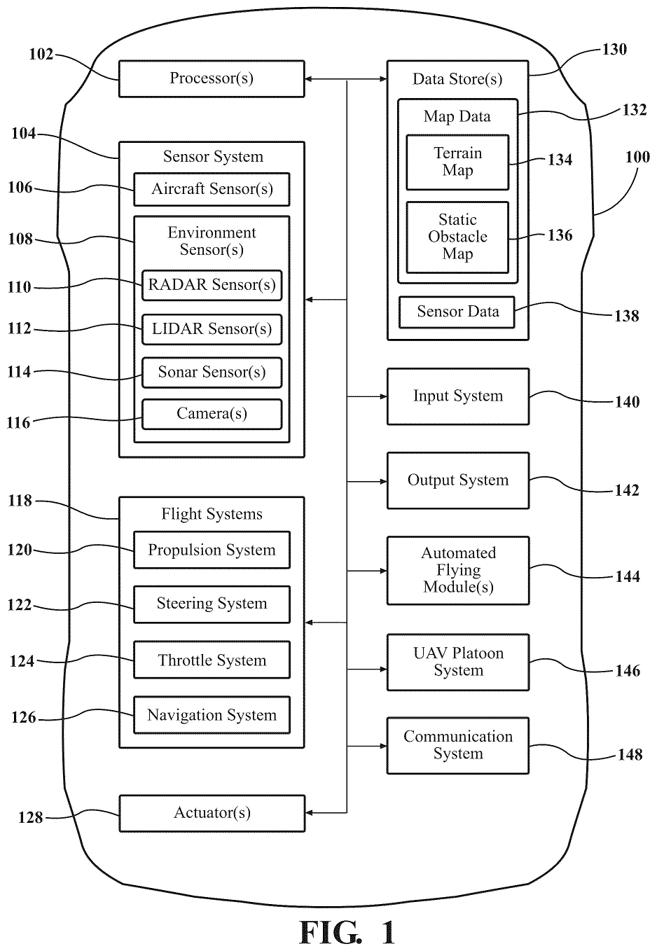

Referring to FIG. 1, an example of a UAV 100 is illustrated. As used herein, an unmanned aerial vehicle 100 is any form of air transport that may be motorized or otherwise powered and not piloted by an onboard pilot. A UAV 100 may include passengers, but in a UAV 100, such passengers are not controlling the flight characteristics/systems of the UAV 100. That is to say, a UAV 100 is not defined by the presence or absence of any individual on the aircraft but rather by the absence of an onboard pilot, where piloting commands are received from a ground-based pilot or an automated control system.

The UAV 100 also includes various elements. It will be understood that in various embodiments, it may not be necessary for the UAV 100 to have all of the elements shown in FIG. 1. The UAV 100 can have different combinations of the various elements shown in FIG. 1. Further, the UAV 100 can have additional elements to those shown in FIG. 1. In some arrangements, the UAV 100 may be implemented without one or more of the elements shown in FIG. 1. While the various elements are shown as being located within the UAV 100 in FIG. 1, it will be understood that one or more of these elements can be located external to the UAV 100. Further, the elements shown may be physically separated by large distances. For example, as discussed, one or more components of the disclosed system can be implemented within a UAV 100 while further components of the system are implemented within a cloud-computing environment or other system that is remote from the UAV 100.

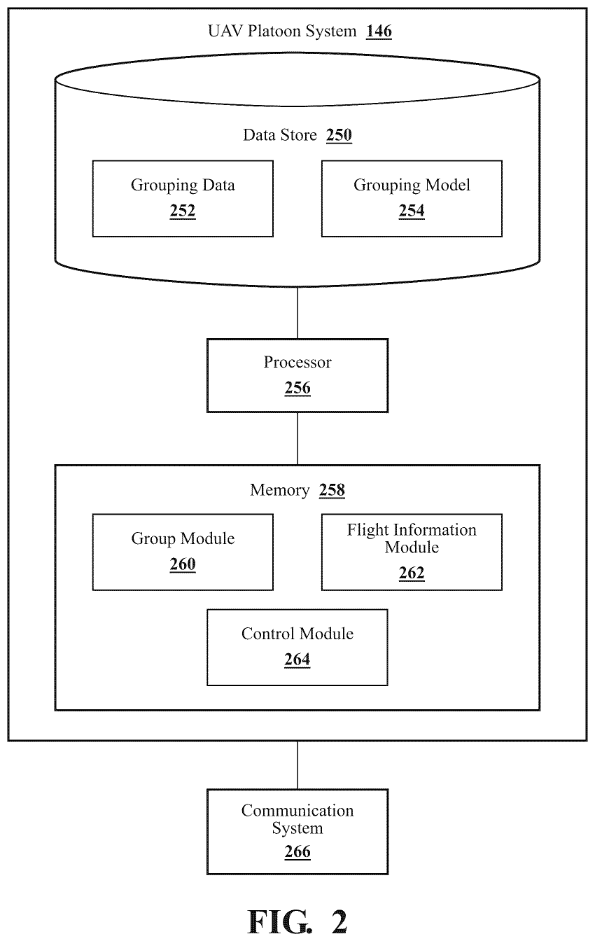

Some of the possible elements of the UAV 100 are shown in FIG. 1 and will be described along with subsequent figures. However, a description of many of the elements in FIG. 1 will be provided after the discussion of FIGS. 2-7 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, the UAV 100 includes a UAV platoon system 146 that is implemented to perform methods and other functions as disclosed herein relating to forming and managing UAV platoons based on intent messages sent and transmitted from various UAVs.

As will be discussed in greater detail, the UAV platoon system 146, in various embodiments, is implemented partially within the UAV 100, and as a cloud-based service. For example, in one approach, functionality associated with at least one module of the UAV platoon system 146 is implemented within the UAV 100, while further functionality is implemented within a remote computing system. Thus, the UAV platoon system 146 may include a local instance at the UAV 100 and a remote instance that functions within the remote computing system.

Moreover, the UAV platoon system 146, as provided for within the UAV 100, functions in cooperation with a communication system 148. In one embodiment, the communication system 148 communicates according to one or more communication standards. For example, the communication system 148 can include multiple different antennas/transceivers and/or other hardware elements for communicating at different frequencies and according to respective protocols. The communication system 148, in one arrangement, communicates via a communication protocol such as WiFi, dedicated short-range communication (DSRC), vehicle-to-infrastructure (V2I), vehicle-to-vehicle (V2V), vehicle-to-everything (V2X), or another suitable protocol for communicating between the UAV 100 and other entities in the cloud environment. Moreover, the communication system 148, in one arrangement, further communicates according to a protocol, such as global system for mobile communication (GSM), Enhanced Data Rates for GSM Evolution (EDGE), Long-Term Evolution (LTE), 5G, or another communication technology that provides for the UAV 100 communicating with various remote devices (e.g., a cloud-based server).

Specific examples of communication protocols include 1) air-to-ground communication protocols (e.g., fourth generation (4G), fifth generation (5G), and sixth generation (6G), etc.), 2) air-to-air communication protocols such as Long-Term Evolution sidelink, 5G new radio (5G NR) sidelink, 6G sidelink, 3) DSRC protocols such as Institute of Electrical and Electronics Engineers (IEEE) 802.11p, and 4) next-generation V2X communication protocols such as IEEE 802.11bd. Still further examples include 1) non-terrestrial networks (NTN) such as high-altitude platform systems (HAPS), low earth orbit (LEO) satellites, medium earth orbit (MEO) satellites, and geostationary orbit (GEO) satellites (e.g., narrowband Internet of things (NBIoT) NTN, LTE enhanced machine-type communication (eMTC) NTN, 5G NR NTN, 6G NTN)) and 2) low-power wide-area networks (e.g., long-range (LoRa), IEEE 802.11ah). In any case, the UAV platoon system 146 can leverage various wireless communication technologies to provide communications to other entities, such as members of the cloud-computing environment.

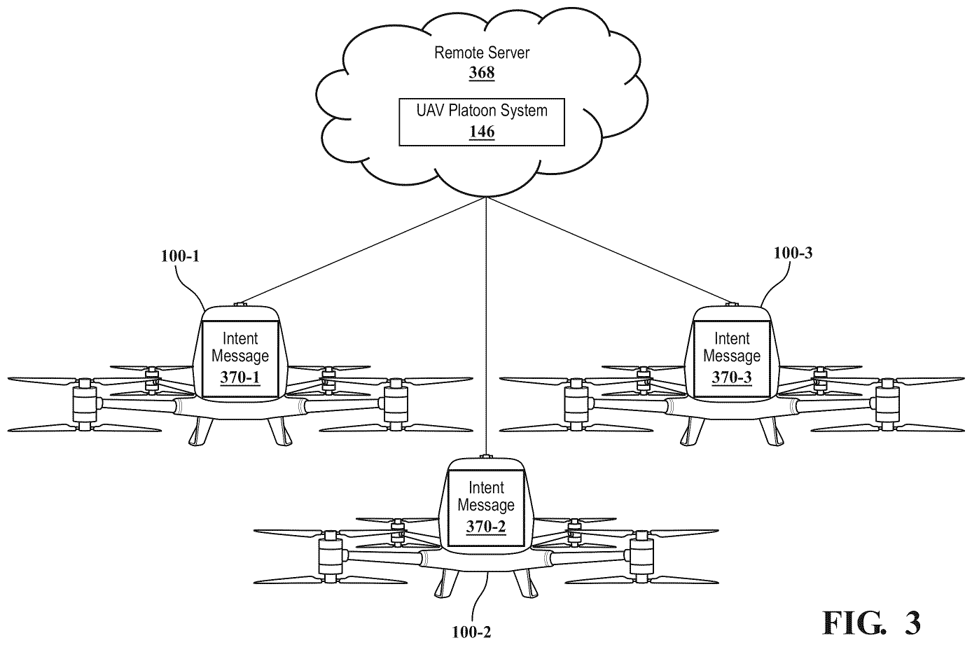

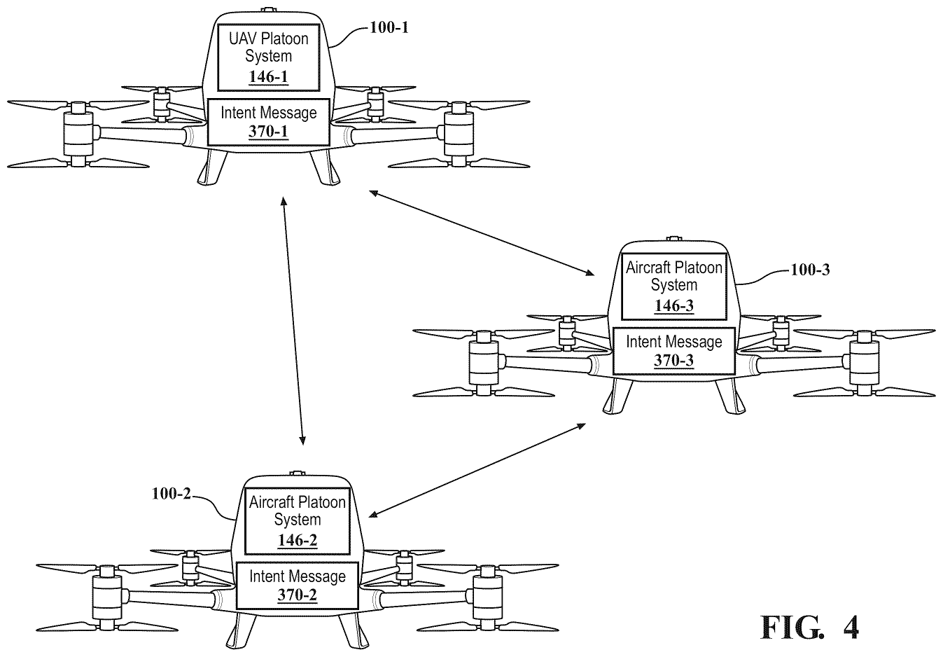

With reference to FIG. 2, one embodiment of the UAV platoon system 146 of FIG. 1 is further illustrated. The UAV platoon system 146 is shown as including a processor 256. In an example where the UAV platoon system 146 is implemented in the UAV 100 (as depicted in FIG. 4), the processor 256 may be an example of the processor 102 from the UAV 100 of FIG. 1. In an example where the UAV platoon system 146 is formed on a remote server (as depicted in FIG. 3), the processor 256 may be a processor of the remote server.

In one embodiment, the UAV platoon system 146 includes a memory 258 that stores a group module 260, a flight information module 262, and a control module 264. The memory 258 is a random-access memory (RAM), read-only memory (ROM), a hard-disk drive, a flash memory, or another suitable memory for storing the modules 260, 262, and 264. The modules 260, 262, and 264 are, for example, computer-readable instructions that, when executed by the processor 256, cause the processor 256 to perform the various functions disclosed herein. In alternative arrangements, the modules 260, 262, and 264 are independent elements from the memory 258 that are, for example, comprised of hardware elements. Thus, the modules 260, 262, and 264 are alternatively application-specific integrated circuits (ASICs), hardware-based controllers, a composition of logic gates, or another hardware-based solution.

Moreover, in one embodiment, the UAV platoon system 146 includes the data store 250. In an example where the UAV platoon system 146 is implemented in the UAV 100, the data store 250 may be an example of the data store 130 from the UAV 100 of FIG. 1. In an example where the UAV platoon system 146 is formed in a remote server, the data store 250 may be a data store of the remote server.

The data store 250 is, in one embodiment, an electronic data structure stored in the memory 258 or another data storage device and that is configured with routines that can be executed by the processor 256 for analyzing stored data, providing stored data, organizing stored data, and so on. Thus, in one embodiment, the data store 250 stores data used by the modules 260, 262, and 264 in executing various functions.

In one embodiment, the data store 250 stores grouping data 252. In general, grouping data 252 is data that is processed by the group module 260 while grouping various UAVs 100 into a platoon. For example, as described in more detail below, in some examples, the UAVs 100 are grouped based on an air corridor and planned path for the candidate UAVs. Accordingly, the grouping data 252 may include at least air corridor information and planned path information for various UAVs 100. That is, each air corridor may be associated with an identifier that differentiates it from other air corridors. In some examples, the identifier may be alphanumeric.

In an example, an air corridor that serves as a basis for the grouping of UAVs 100 may be vertical or horizontal. For example, UAVs 100 traveling in a generally horizontal direction may be grouped into a horizontal air corridor. As other examples, UAVs 100 may travel vertically between horizontal air corridors or take off from a building. In this example, the vertically moving UAVs 100 may be grouped based on the vertical air corridor in which they are traveling.

As described above, this information may be received from the UAVs 100 via the communication system 266, which may be an example of the communication system 148 of the UAV 100 when the UAV platoon system 146 is implemented in a UAV 100 or another similar type of communication system on a remote server.

In an example, the air corridor and planned path for a UAV 100 may be received via an intent message received from various UAVs. In an example, the grouping data 252 may include other information extracted from the intent messages from various UAVs 100. In one example, the intent messages include position data for a respective UAV 100. Examples of position data include global positioning system (GPS) coordinates or other location-indicating data. In another example, the position data includes the altitude of the respective UAV 100. As described, UAVs 100 may be grouped based on the air corridor in which they fly. In some examples, the air corridors are defined, at least in part, by an altitude range. Accordingly, the altitude data may be relied on to determine an air corridor for the respective UAV 100. In another example, the intent message may directly identify, by an identifier as described above, an air corridor where it is flying.

As another example, the position information may indicate an orientation of the UAV 100. For example, during flight, a UAV 100 may have a pitch (i.e., rotation about a side-to-side axis) and rotation (i.e., rotation about a front-to-back axis). This information may also be included in the position data and relied on to group certain UAVs 100.

In another example, the position data may include future position data for a respective UAV 100. Specifically, in some examples, the position data may include a planned path for the respective UAV 100 over a specified time window. For example, the intent message may indicate the planned path of the respective UAV 100 for a time window on the order of multiple seconds.

In an example, the format of the planned path data may be of various types. For example, the planned path could include a numerical sequence of numbers that define the latitude/longitude of the UAV 100 at various points in time or that otherwise identify the time-based location of the UAV 100. In one particular example, the planned path data may also include dynamics data for the UAV 100 as it travels along the path. Examples of dynamics data for a planned path include a time-based speed, acceleration, and/or deceleration of the UAV 100 along the planned path, as well as dynamics (e.g., speed, acceleration, deceleration, etc.) of the UAV 100 as it performs certain maneuvers (e.g., take-off, land, turn). This and other information may be included in the grouping data 252 as position data for a respective UAV 100.

As another example, the intent messages may include data characteristic of the respective UAV 100. For example, the UAV characteristic data may indicate the type, size, and/or shape of the UAV 100. For example, it may be desirable to group UAVs 100 together based on a type (e.g., eVTOL, VTOL, drone), size (e.g., small, medium, and large) as similar types, sizes, and/or shapes of UAVs 100 may exhibit similar flight characteristics that are conducive to grouping and coordinated flight. For example, a large eVTOL that carries passengers may not be able to accelerate, decelerate, or turn as quickly as a smaller eVTOL that carries small packages. Accordingly, this UAV characteristic data may be relied on in grouping UAVs 100. As other examples, the UAV characteristic data may include the dynamic capabilities/ranges for the UAV 100. Examples of dynamic capabilities/ranges for the UAV 100 include UAV minimum/maximum airspeeds, UAV horizontal and/or vertical acceleration and deceleration ranges, turn radiuses, etc. While particular reference is made to particular dynamic capabilities/ranges, other dynamic capabilities/ranges for the UAV 100 may be included in the grouping data 252.

Another example of UAV characteristic data is air traffic controller connection status data. That is, the UAV characteristic data may indicate whether a UAV 100 is in communication with, or under the control of, an air traffic controller. The air traffic controller connection status data may also include an associated air traffic controller identifier. As air traffic controllers provide guidance and safety to aircraft under their purview, in some examples, a platoon may be allowed when under the oversight of an air traffic controller.

Another example of UAV characteristic data is the cargo of the UAV 100. That is, some UAVs 100 may carry freight (such as in package delivery), and others may carry passengers. In either of these cases, the cargo of the UAV 100 may dictate certain coordinated flight parameters. For example, sharp turns and quick accelerations/decelerations may be jarring to a passenger. Accordingly, it may be desirable for a passenger transport UAV 100 to be grouped with other passenger transport UAVs 100 where more gentle flight parameters might be established as opposed to being grouped with freight delivery UAVs 100, which may be able to travel faster due to the lack of passengers and considerations regarding passenger safety and comfort.

In any case, this data and others may be extracted from the intent messages received from various UAVs 100, processed, analyzed, and/or cataloged for use by the group module 260 to form UAVs 100 into platoons. In one embodiment, the data store 250 stores the grouping data 252 along with, for example, metadata that characterize various aspects of the grouping data 252. For example, the metadata can include time/date stamps from when the separate grouping data 252 was generated, and so on. The metadata may also identify the UAV 100 to which the grouping data 252 is associated. Accordingly, once the group module 260 identifies sufficiently similar grouping data 252, the group module 260 may identify respective UAVs 100 to be grouped based on the metadata associated with the grouping data 252. The flight information module 262 may generate flight instructions for the platoon, and the control module 264 may fly the platooned UAVs 100 to exhibit coordinated flight.

In some examples, the grouping data 252 includes additional data such as weather data collected from a weather station, for example, via the communication system 266. Weather data may also impact whether certain UAVs 100 may be grouped or whether grouping should occur at all. For example, high winds in an area may make it unsuitable for any UAV 100, or UAVs 100 that are particularly susceptible to being negatively impacted by wind (e.g., small UAVs 100 without position control or UAVs 100 that are carrying particular cargo such as passengers) to be grouped into platoons. Accordingly, in this example, in addition to relying on intent message extracted data, the grouping data 252 may include additional data such as weather data. That is, the UAV platoon system 16 may receive discretized packets indicating information from a weather station.

In another example, the grouping data 252 may include additional data, such as data that may be received from an air traffic controller via the communication system 266. That is, the UAV platoon system 146 may receive discretized packets indicating information from an air traffic controller.

Air traffic control data may be of various types and generally indicate non-weather-based environmental conditions and air travel restrictions. For example, air traffic control data may include restrictions for travel in general and/or within specific air corridors. For example, certain air corridors may allow passenger transport and freight haul, some air corridors may be reserved just for freight hauling (i.e., not passenger transport), and others may be reserved for passenger transport and not freight hauling. The air traffic control data may include this information that, along with the cargo indicia extracted from intent messages, may guide UAV grouping.

The air traffic control data may also indicate other travel restrictions. For example, platooning may be prohibited during certain hours of the day. Accordingly, the air traffic control data may record these and other travel restrictions.

As another example, specific air corridors may have limits on air traffic capacity. For example, no more than a threshold number of UAVs 100 may be permitted within a single air corridor. The air traffic control data may indicate the limits, if any, of particular air corridors and whether the capacity within a particular corridor is at or exceeds the limit.

As another example, the air traffic control data may indicate temporary restrictions/situations that preclude UAV platooning. For example, a communication network through which coordinated platoon flight is managed may be out of service. Accordingly, the air traffic control data may indicate this or another temporary restriction, so the group module 260 may avoid grouping. While particular reference is made to particular air traffic control data, the grouping data 252 may include other types of data on which the group module 260 may base any UAV 100 grouping.

In one embodiment, the data store 250 further includes a grouping model 254, which may be relied on by the group module 260 to group UAVs 100 into a platoon. As described above, UAVs 100 with similar characteristics (e.g., similar air corridors, planned paths, UAV characteristics, etc.) may be grouped in a platoon and fly together in formation. Accordingly, the group module 260 may compare the air corridor, planned paths, position data, characteristics of the UAVs 100, and other information to determine whether or not such are sufficiently similar to be grouped. That is, the grouping model 254 may include the criteria, metrics, or algorithms by which the group module 260 evaluates whether grouping data 252 associated with different UAVs 100 is sufficiently similar for the respective UAVs 100 to be formed into a platoon. In some examples, the comparison may be to determine whether two data points match. For example, the group module 260 may compare air corridor identifiers. If the air corridor identifiers match and planned paths (e.g., planned paths over a predetermined time window) for respective UAVs 100 match, the respective UAVs 100 may be grouped in a platoon. In other examples, the comparison may be more complex. For example, the grouping model 254 may include thresholds against which similarity is determined. For example, the grouping model 254 may include thresholds against which the differences between planned paths are compared to determine if such are sufficiently similar to justify combining respective UAVs 100 into a platoon. For example, it may be that the planned paths of two UAVs 100 are not identical but similar. In this example, the grouping module 260, relying on the thresholds or other algorithms in the grouping model 254, may determine that the planned paths are similar enough that the two UAVS 100 may be grouped, albeit with an alteration to a flight path of at least one of the two UAVs 100.

In another example, whether or not UAVs 100 are grouped is based on additional operational metrics. Examples of such additional metrics include safety, energy efficiency, air corridor capacity, and cargo metrics. For example, it may be that a platoon size greater than a threshold value may exhibit an increased danger to the freight or passengers in a UAV 100 or to the UAVs 100. Accordingly, if a platoon would include more than the threshold value of UAVs 100, platoon formation may be restricted to a sub-threshold number.

As another example and as described above, it may be desirable to group UAVs based on cargo type. For example, it may be desirable to group freight UAVs as transporting freight may enable higher speeds and flight that would otherwise be uncomfortable for a passenger (e.g., tight turns, quick acceleration/deceleration). In this example, the grouping model 254 includes the cargo metrics, criteria, and algorithms used to evaluate the cargo-related data for various UAVs 100 when grouping.

As yet another example, the ability to group UAVs 100 and the size of the platoons may be based on the air corridor capacity. That is, there may be a threshold number of UAVs 100 permitted in an air corridor, with the threshold number varying based on criteria such as types of UAVs 100 in the air space, time of day, weather conditions, etc. In this example, the grouping model 254 may include the criteria, thresholds, and algorithms, in some examples cataloged by the different environmental conditions, by which it is determined that a safe and efficient UAV platoon can be formed. While particular reference is made to one particular safety metric, other metrics such as energy, air corridor capacity, and cargo metrics may be similarly evaluated when grouping UAVs 100.

The thresholds and metrics may vary based on several factors, including UAV type, weather, overall air traffic, time of day, etc. Accordingly, the grouping model 254 may be any model that guides the analysis and processing of grouping data 252 under various circumstances. In any case, the grouping model 254 may include the weights, thresholds, variables, offset values, algorithms, parameters, and other elements that the group module 260 relies on to output a UAV 100 platoon. In an example, the specific values, weights, thresholds, variables, offset values, algorithms, parameters, and other elements may be input by an administrator of the UAV platoon system 146 and/or learned via a machine-learning model. The specific metrics by which UAVs 100 are grouped may vary and may be determined empirically or learned by a machine-learning model trained (supervised or unsupervised) on previous data sets. Examples of machine-learning models include, but are not limited to, logistic regression models, Support Vector Machine (SVM) models, naïve Bayes models, decision tree models, linear regression models, k-nearest neighbor models, random forest models, boosting algorithm models, and hierarchical clustering models. While particular models are described herein, the group model 254 may be of various types.

The UAV platoon system includes a group module 260 that, in one embodiment, includes instructions that cause the processor 256 to 1) receive intent messages from a plurality of UAVs 100. The intent message includes various pieces of information, including an air corridor and planned path for a respective UAV 100. As depicted in FIG. 1, each UAV 100 may include a processor 102, an automated flying module 144, and various flight systems 118 that generate or receive data to facilitate the unmanned navigation of the UAV 100. As part of the operation of the UAV 100, these components may generate intent messages, which include various pieces of data as described above relative to the characteristics of the position and travel of the UAV 100 as well as various characteristics of the UAV 100 itself. For example, a navigation system 126 of the UAV 100 may generate and/or store a planned path for the UAV 100. The format of the planned path may vary and may include, for example, a sequence of longitude and latitude waypoints along the route of the UAV 100, in some examples, the route may be smoothed rather than consisting of jagged straight lines connecting the waypoints. Similarly, aircraft sensors 106, such as GPS or other position sensors, may determine the position and altitude of the UAV 100. In some examples, the data store 130 of the UAV 100 may include other information, such as the air corridor in which the UAV 100 is located. In one particular example, the processor 102, relying on information in the data store 130, may calculate the air corridor in which the UAV 100 is found. For example, each air corridor may be associated with a particular altitude range. Accordingly, in conjunction with the altitude information for the UAV 100, as determined by aircraft sensors 106, the processor 102 may be able to determine the air corridor in which the UAV 100 is found. This information and other information may be packaged into an intent message, which may be a data package including various pieces of information, and transmitted to the group module 260.

The UAV platoon system 146, whether on a remote server or one of the UAVs 100 to be grouped, may process the information for various intent messages to form a group of UAVs 100. That is, the communication system 266 of the remote server or one of the UAVs 100 may communicate with UAVs 100 via their respective communication systems 148 to receive/transmit intent messages and store such as grouping data 252 in the data store 250.

The group module 260 includes instructions that cause the processor 256 to group, based on the air corridor and planned path in multiple intent messages, a set of UAVs 100 into a platoon. That is, each intent message includes, among other things, the air corridor for a respective UAV 100 and a planned path for the respective UAV 100. Based on the similarity of such, the group module 260 may pair specific UAVs 100 that have the same or similar air corridor identifier and/or planned path.

For example, as described above, each air corridor may have an identifier, such as an alphanumeric identifier, that differentiates the air corridor from others. The air corridor associated with a particular UAV 100 may be stored on the UAV 100 or otherwise calculated by the UAV 100 and transmitted to the UAV platoon system 146. UAVs 100 found in the same air corridor and having the same or similar planned path over a predetermined window may be grouped together. Note that UAVs 100 may be grouped based on a shared horizontal or vertical corridor. That is, UAVs 100 traveling horizontally may be in a horizontal air corridor, and UAVs 100 traveling vertically may be in a vertical air corridor. In either case, the air corridor may be associated with a particular identifier referenced in intent messages from UAVs 100 found within the respective air corridor.

Still further, UAVs 100 may be grouped based on the planned path. That is, autonomously controlled UAVs 100 follow a path, which may be generated by an automated flying module 144 and/or a navigation system 126 of the UAV 100. In this example, the flight path may be logged in the UAV 100 and included in a transmitted intent message. The group module 260 may compare planned paths and group UAVs 100 with planned paths having a threshold similarity, which threshold similarity may be stored in the grouping model 254. In an example, the similarity by which planned paths are grouped may include a threshold distance between waypoints of the planned path. Accordingly, the group module 260 may identify the similarity between waypoints of different planned paths and average, combine, or otherwise aggregate the difference between waypoints. If the difference is below some predetermined threshold value, as determined by the grouping model 254, the group module 260 may group the associated UAVs 100 into a platoon. Note that the planned path, as included in an intent message, may be a path over a particular period, for example, several seconds to several minutes. Accordingly, while UAVs 100 may have different starting and ending locations or different routes between the starting and ending locations, these UAVs 100 may still be grouped if an analysis of their several second-based planned paths coincide with one another or are within a threshold difference from one another. Once the planned paths differ by greater than a threshold amount, as defined in the grouping model 254, this UAV platoon may be dissolved or diverging UAVs 100 removed from the platoon to continue to their intended destination.

Note that while particular reference is made to single criteria comparison (e.g., air corridor to air corridor and planned path to planned path), in an example, the group module 260 performs a multi-factor comparison. For example, it may be that each variable (e.g., air corridor and planned path) are to be within a threshold difference from one another or the differences between planned paths are weighted in some fashion and combined into an aggregate representation of the difference between air corridors and planned paths of different UAVs 100.

Moreover, as described above, the group module 260 may group the UAVs 100 based on other content in the intent messages, such as flight dynamics (e.g., speed, acceleration/deceleration rates, maneuver rates, etc.), UAV characteristic data, air traffic controller connection status data and the like. In these examples, the group module 260 may weigh each factor separately or in the aggregate to determine which UAVs 100 could be grouped into a platoon.

As a specific example, the group module 260 may analyze similarly categorized pieces of grouping data 252 (e.g., planned paths, air corridors, UAV dynamic ranges, UAV characteristics) to determine which are sufficiently similar to one another. Again, it may be the case that each UAV 100 has unique and specific characteristics (e.g., speed ranges, acceleration/deceleration ranges, turn radiuses, and maneuver execution rates). Accordingly, the group module 260, rather than group UAVs 100 that exactly match, may match those UAVs 100 with a threshold similarity defined by the predetermined criteria, metrics, and thresholds in the grouping model 254. That is to say, the group module 260 may cluster various UAVs 100 based on their respective intent messages. Various specific grouping algorithms may be implemented, such as centroid-based clustering, density-based clustering, distribution-based clustering, and hierarchical clustering, to name a few. While particular reference is made to particular multi-factorial clustering operations, the group module 260 may implement any type of clustering algorithm that considers multiple categories of data to group UAVs 100.

In one approach, the group module 260 implements and/or otherwise uses a machine learning algorithm. In one configuration, the machine learning algorithm is embedded within the group module 260, such as a convolutional neural network (CNN), to perform semantic segmentation over the grouping data 252, from which further information is derived. Of course, in further aspects, the group module 260 may employ different machine learning algorithms or implement different approaches for performing the semantic segmentation, which can include deep convolutional encoder-decoder architectures, a multi-scale context aggregation approach using dilated convolutions, or another suitable approach that generates semantic labels for the separate object classes represented in the image. Whichever particular approach the group module 260 implements, the group module 260 provides an output with semantic labels identifying objects represented in the grouping data 252. In this way, the group module 260 generates groups of UAVs 100 that are to exhibit coordinated flight along a particular path.

Once the group module 260 identifies air corridors, planned paths, and other sufficiently similar data, the group module 260 identifies UAVs 100 associated with similar data sets, for example, via metadata that identifies the respective UAVs 100. The identifiers may be passed to the control module 264, which uses the identifiers when flying the respective UAVs 100, controlling the respective UAVs 100, or otherwise transmitting flight data to the UAVs 100, which flight data controls the movement of the respective UAVs 100.

In one or more configurations, the UAV platoon system 146 implements one or more machine learning algorithms. As described herein, a machine learning algorithm includes but is not limited to deep neural networks (DNN), including transformer networks, convolutional neural networks, recurrent neural networks (RNN), etc., Support Vector Machines (SVM), clustering algorithms, Hidden Markov Models, and so on. It should be appreciated that the separate forms of machine learning algorithms may have distinct applications, such as agent modeling, machine perception, and so on.

Moreover, it should be appreciated that machine learning algorithms are generally trained to perform a defined task. Thus, the training of the machine learning algorithm is understood to be distinct from the general use of the machine learning algorithm unless otherwise stated. That is, the UAV platoon system 146 or another system generally trains the machine learning algorithm according to a particular training approach, which may include supervised training, self-supervised training, reinforcement learning, and so on. In contrast to training/learning of the machine learning algorithm, the UAV platoon system 146 implements the machine learning algorithm to perform inference. Thus, the general use of the machine learning algorithm is described as inference.

It should be appreciated that the group module 260, in combination with the grouping model 254, can form a computational model such as a neural network model. In any case, the group module 260, when implemented with a neural network model or another model, in one embodiment, implements functional aspects of the grouping model 254 while further aspects, such as learned weights, may be stored within the data store 250. Accordingly, the grouping model 254 is generally integrated with the group module 260 as a cohesive functional structure.

The UAV platoon system 146 includes a flight information module 262 that includes instructions that, when executed by the processor 256, cause the processor 256 to generate a coordinated flight path and coordinated flight parameters for the platoon. As described above, coordinated flight among UAVs 100 has several benefits, including energy efficiency as the UAVs 100 may fly in a formation that reduces wind resistance. In another example, coordinated flight among UAVs 100 may reduce air traffic as rather than having multiple small entities (i.e., individual UAVs 100) independently flying in an air corridor, larger but fewer entities (i.e., UAV platoons) may navigate a particular air corridor in a coordinated fashion. Accordingly, the flight information module 262 generates the flight information for a platoon.

The coordinated flight path may be the location coordinates of waypoints that the platoon follows over time. Similar to the individual UAV planned path, the waypoints of the coordinated flight path may include a series of waypoints, which may follow map-based routes or avoid obstacles, such as buildings. As such, the flight information module 262 may rely on map data 132, which indicates static objects such as buildings and other obstructions that may be found within a given region and that should be avoided.

In an example, the flight path indicates a path through predetermined airways. That is, an airspace may be made up of a network of airways in much the same way that the ground is covered by a network of roadways across which wheeled vehicles travel. Accordingly, the flight path may guide the platoon along airways in the airspace along these particular airways. In another example, the flight path for the platoon may be one of the planned paths of the UAVs 100 in the platoon, some combination (e.g., averaged) of the planned paths of the individual UAVs 100 that form the platoon, or another predetermined planned path, which predetermined planned path may be determined by a machine-learning operation.

In addition to generating the coordinated flight path, the flight information module 262 may generate coordinated flight parameters for the platoon, which coordinated flight parameters indicate how the different UAVs 100 in the platoon should fly. The flight parameters that are selected may be of various types. For example, a flight parameter may be the speed of the UAVs 100 along the route or at different points along the route. In another example, the flight parameters may be a formation (e.g., single file vs. V-formation). Other examples include platoon duration, acceleration ranges, deceleration ranges, and boundaries on the time to complete certain aerial maneuvers (e.g., taking off, landing, turning, etc.).

In a specific example, a flight parameter may be the speed of the UAVs 100 in the platoon. That is, the flight information module 262 may determine the speed for each of the UAVs 100 in the platoon. In an example, the flight parameters (e.g., speed, acceleration rangles, deceleration rangles, and boundaries on the time to complete certain aerial manauevers may be those indicated in the intent message of one of the UAVs 100 in the platoon, some combination (e.g., averaged) of the flight parameters of the individual UAVs 100 that form the platoon, or other predetermined flight parameters, which predetermined flight parameters may fall within the limits of each UAV 100 of the platoon and in some cases may be determined by a machine-learning operation and may fall within.

In another example, the flight information module 262 may determine a formation for the platoon. In general, the platoon may dictate a leader-follower formation where the UAVs 100 are arranged in a single file formation where each following UAV 100 flies directly behind a UAV 100 in front of them. As another example, rather than flying in a single file line, the UAVs 100 may be arranged into a V formation where the following UAVs trail behind and laterally to the side of a UAV 100 in front of them.

In other examples, the flight information module 262 may determine the duration of the platoon. Once the duration expires, the UAVs 100 may return to being individually controlled by an onboard automated flying module 144 or a ground-based controller. Other examples of flight parameters that might be set include an acceleration range, a deceleration range, and maneuver execution boundaries. Maneuver execution boundaries may refer to upper and lower time limits within which a UAV 100 is to perform a particular maneuver. For example, the flight information module 262 may instruct the UAVs 100 in a platoon to perform a 90 degree turn over 5 seconds at a particular heading.

As another example, the flight information module 262 may set a following distance. The following distance may be a distance that a following UAV 100 trails a previous UAV 100 in the platoon. This value may be set based on various metrics, which may be defined by the group module 260. Another example of an operational metric used to define the coordinated flight parameters is the air corridor capacity. For example, it may be that during one leg of a trip, the UAVs 100 are to fly in an air corridor with sub-threshold capacity. However, at another point in time, the UAVs 100 may fly to a region where the air corridor capacity rises above the threshold. In this example, the UAVs 100 may be directed to move to another air corridor where they can operate without causing the quantity of UAVs 100 in that air corridor to rise above its threshold. That is, the operational metrics (e.g., safety, energy, air corridor capacity, and cargo) may be used to define the platoon and, in this example, may also be used to define the coordinated flight path and/or coordinated flight parameters.

Note that in this and other examples, the coordinated flight path and coordinated flight parameters may be set per UAV 100. For example, each UAV 100 in a platoon may have different parameters. As a specific example, a following UAV 100 may be behind a lead UAV 100 in the platoon and, as such, may have a different absolute position in airspace relative to the first.

The UAV platoon system 146 includes a control module 264 that includes instructions that, when executed by the processor 256, cause the processor 256 to fly the set of UAVs 100 based on the coordinated flight path and the coordinated flight parameters. Initially, the control module 264 may establish a communication link with the UAVs 100 that have been grouped together. This may include a handshake operation whereby the UAVs 100, as identified by metadata, are sent requests to establish a communication link, and authorize such. Once established, control data whereby the flight systems 118 of the UAVs 100 in the platoon may be transmitted. That is, the control module 264 may configure components of the UAVs 100 in the platoon to follow the coordinated flight path and the coordinated flight parameters.

Specifically, the control module 264 may transmit control signals that alter the operation of the different flight systems 118 of the UAVs 100 to follow the coordinated flight path. As a particular example, the control module 264 may transmit signals that alter the propulsion system 120 to operate rotors of the UAV 100 to move the UAV 100 along a particular path at a particular speed. In another example, the control module 264 may transmit control signals that provide the navigation system 126 with a flight path and parameters. In this example, the navigation system 126, in coordination with the other flight systems 118 and/or the automated flying modules 144, controls the various flight systems 118 such that the UAV 100 follows the indicated flight path with the various coordinated flight parameters. As described above, flying the set of UAVs 100 may include causing the processor 256 to control at least one of a flight plan, a flight parameter, a flying formation, a flight speed, a duration of the platoon, an acceleration range, a deceleration range, or maneuver execution boundaries.

The UAV platoon system 146, as illustrated in FIG. 2, is generally an abstracted form of the UAV platoon system 146 as may be implemented between the UAV 100 and a remote server-based environment or a peer-to-peer environment. FIG. 3 illustrates an example of a remote server 368 that may be implemented along with the UAV platoon system 146. As illustrated in FIG. 3, the UAV platoon system 146 is embodied at least in part within a remote server 368.

In one or more approaches, the remote server 368 may facilitate communications between multiple different UAVs 100-1, 100-2, and 100-3 to acquire and distribute information between UAVs 100-1, 100-2, and 100-3. Specifically, the remote server 368 may receive the intent messages 370-1, 370-2, and 370-3 from the various UAVs 100-1, 100-2, and 100-3 via respective communication systems 148 and 266 as described above. The group module 260 may then group the UAVs 100-1, 100-2, and 100-3 as described above and control the flight of the UAVs 100-1, 100-2, and 100-3 as described above.

As described above, each UAV 100-1, 100-2, and 100-3 may generate an intent message 370-1, 370-2, and 370-3. The intent messages 370-1, 370-2, and 370-3 include various pieces of data, such as an air corridor in which the respective UAV 100 is found and a planned flight path for the respective UAV 100. In addition to this information, the intent messages 370-1, 370-2, and 370-3 may include other information such as position information for the respective UAV 100, UAV characteristic data for the respective UAV 100, and air traffic controller connection status data for the respective UAV 100 as described above. In general, the group module 260 includes instructions that cause the processor 256 to group the set of UAVs 100 based on at least one of these position data, UAV characteristic data, and air traffic controller connection status data.

Specific examples of some of the content of the intent messages 370-1, 370-2, and 370-3 will now be provided. As described above, the intent messages 370-1, 370-2, and 370-3 may include position information such as GPS coordinates, an altitude, a pitch, and a roll of the respective UAV 100-1, 100-2, and 100-3 among other information. Example information that may be included in the position information may include a numeric indication of a GPS station identifier, a latitude and longitude of the UAV 100, a speed of the UAV 100, a heading of the UAV 100, an altitude of the UAV 100, a pitch of the UAV 100, and a roll of the UAV 100. As described above, the specific numeric values for each data point may be compared with information extracted from the intent messages 370 of other UAVs 100 while grouping the various UAVs 100.

The position information may also include an indication of the planned path of the UAV 100. In an example, the intent messages 370-1, 370-2, and 370-3 may include a numerical representation of a planned path. In general, the path of a UAV 100 may be defined as a series of waypoints along a path. In some examples, the planned path may have a smoothened shape rather than rigid straight connections between adjacent waypoints. For example, the planned path may include a representation of the clothoid curve of the UAV 100. A clothoid curve is a sequence of numbers that define a curved path of a traveling object from one point to another. In another example, the planned path may be a sequence of latitude and longitude coordinates for the different waypoints along the planned path.

As described above, the intent messages 370-1, 370-2, and 370-3 may also include dynamic ranges for the UAV 100 along the planned path. For example, the intent message 370 may indicate a speed range (e.g., between 20-25 miles per hour (mph)), acceleration and deceleration ranges, and rates at which particular maneuvers are to be executed. In some examples, the dynamic ranges may be represented as multiple numeric representations of the speed range and other dynamic values (e.g., acceleration between −1 and +1 meters per second squared).

The intent messages 370-1, 370-2, and 370-3 may also include other information such as UAV characteristics (e.g., UAV size, UAV shape, UAV type, UAV cargo, UAV dynamic ranges), etc. As described above, the grouping may be based on these criteria. In other examples, the flight information may also be based on these criteria. For example, a planned path may avoid a certain area when carrying passengers. As another example, the time limits to perform a particular maneuver may be shortened when the UAVs 100 in a platoon are smaller, as smaller UAVs 100 may be able to execute particular maneuvers more quickly.

As described above, the intent messages 370-1, 370-2, and 370-3 may also include an identifier of an air corridor in which the respective UAV 100 is flying. In an example, this may include an integer value indicating an identifier of the air corridor in which the UAV 100 is found. In an example, one portion of the identifier (e.g., a prefix integer) or an entirely different integer value may indicate that the UAV is not in an air corridor. That is, it may be that a UAV 100 is flying over a region outside of the defined air corridors for the region. In this example, a prefix bit or a distinct integer value may be appended to or replace the air corridor identifier. In this example, the presence of the UAV 100 outside of an air corridor may prevent the respective UAV 100 from being joined in a group.

The intent messages 370-1, 370-2, and 370-3 may also include an integer value that indicates an air traffic controller identifier associated with (e.g., in control of) the respective UAV 100. Similarly, a prefix portion (e.g., a prefix bit) or another integer value may indicate that the respective UAV 100 is not connected with any air traffic controller.

The intent messages 370-1, 370-2, and 370-3 may include other information, such as an integer value to indicate wind/air currents as measured by the environment sensors 108. Such an integer value may reflect wind speeds and directions, among other information. This information may be used alone or in conjunction with weather data collected by a weather station to identify wind conditions unsuitable for platoon formation or to alter the configuration of a UAV platoon based on the weather conditions (e.g., determine the number, type, and speed of UAVs 100 in the platoon).

The intent messages 370-1, 370-2, and 370-3 may also include a duration that may be an integer value indicating a time duration that the current conditions have been detected. That is, the duration may reflect how long the UAV 100 has been in a particular air corridor, how long current wind/air conditions have been recorded, how long the UAV 100 has been in communication with a particular air traffic controller, etc. Other examples of information that may be included in the intent message include an integer representation indicating the duration of the platoon and an integer representation indicating a preferred formation for the platoon.

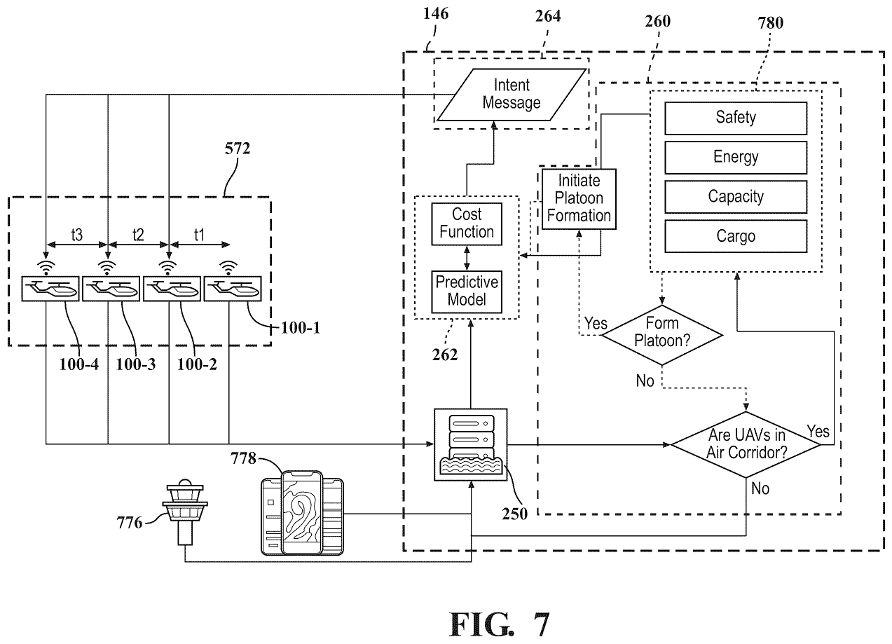

As described above, the data in the intent messages 370-1, 370-2, and 370-3 may be used to 1) group particular UAVs 100 into platoons as described above and 2) define coordinated flight plans and/or parameters for the platoon. To control the operation of the UAVs 100 in the platoon, the control module 264 may include instructions that cause the processor to transmit the coordinated flight path and flight parameters to the UAVs 100 to exhibit coordinated flight. In some examples, as depicted in FIG. 7, this may include transmitting an altered intent message to the UAVs 100. For example, the altered intent messages may include different planned paths for the UAVs 100 in the platoon. In an example, the altered intent messages may include signals that re-configure the flight systems 118 of the UAVs 100 to fly along the coordinated flight paths using the coordinated flight parameters. For example, the altered intent messages may include signals that re-configure the UAVs 100 to operate with dynamic ranges (e.g., speed thresholds, acceleration/deceleration thresholds, maneuver thresholds, etc.) for the flight plans. Each UAV 100 may then extract and process the signals in the intent messages to control their respective flights. In this example, the control module 264 controls the flight of the UAVs 100 in the platoon by transmitting these altered intent messages.

FIG. 4 illustrates one embodiment of the aircraft platoon system of FIG. 2 in a peer-to-peer computing environment. In the example depicted in FIG. 4, rather than relying on a server 368, each UAV 100-1, 100-2, and 100-3 may be equipped with a respective UAV platoon system 146-1, 146-2, and 146-3. Accordingly, one of the UAVs 100 may govern the grouping of UAVs 100, the generation of flight information, and the control of the other UAVs 100 in the platoon. For example, a first UAV 100-1 may broadcast a request for intent messages 370. Responsive to this request, other UAVs 100-2 and 100-3 may transmit their respective intent messages 370-2 and 370-3. The first UAV 100-1 may compare the intent message 370-2 and 370-3 information with its own intent message 370-1 as described above and identify which of the UAVs 100-2 and 100-3 is suitable for joining to a platoon with the first UAV 100-1. That is to say, the functionality described above regarding the UAV platoon system 146 may be implemented on the UAVs 100 themselves. Doing so may avoid any issues arising when communication between a UAV 100 and a remote server 368 is lost, for example, due to interference from city infrastructure. Accordingly, as shown, the UAV platoon system 146 may include separate instances within UAVs 100s that function cooperatively to acquire, analyze, and distribute the noted information.

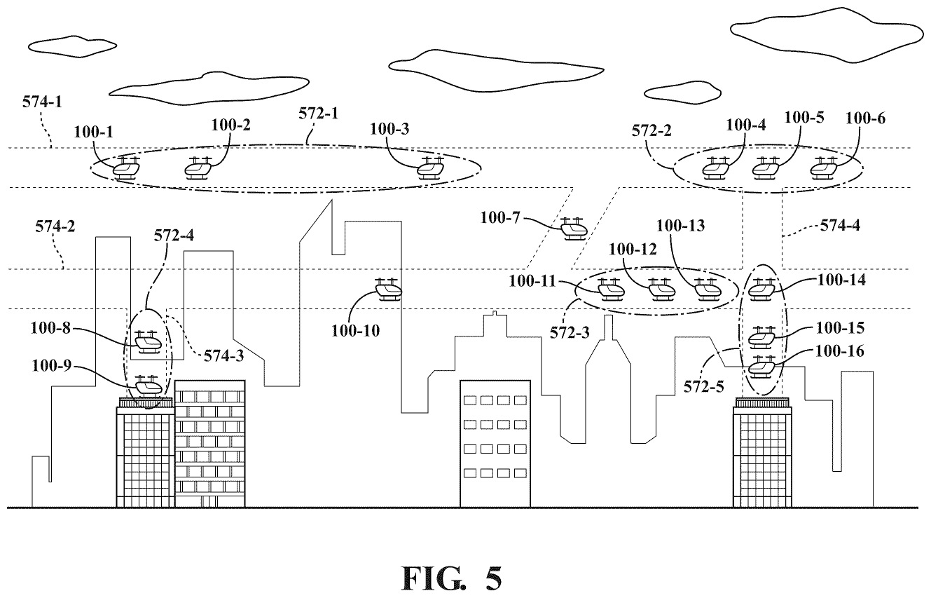

FIG. 5 illustrates the formation and management of a UAV platoon 572. As described above, airspace may be divided into air corridors 574. The air corridors 574 may be horizontal corridors 574-1 and 574-2 or vertical corridors 574-3 and 574-4. In general, an air corridor 574 is a predefined aerial highway for UAVs 100. Each horizontal corridor 574-1 and 574-2 may occupy several altitudes, and each vertical corridor 574-3 and 574-3 may extend between horizontal corridors 574-1 and 574-2 or from a ground surface or building top to a horizontal corridor 574-1 and 574-2. These air corridors 574 are meant to organize air traffic and prevent potential collisions between UAVs 100 flying therein.

As described above, UAVs 100 may be grouped based on their respective air corridor 574. For example, a first UAV 100-1, a second UAV 100-2, and a third UAV 100-3 may be grouped into a first platoon 572-1 based on these UAVs being in a first air corridor 574-1, having a similar flight path, and being within a threshold distance of one another, which threshold distance may be defined by the grouping model 254. By comparison, the fourth UAV 100-4, fifth UAV 100-5, and sixth UAV 100-6 may not be grouped within the first platoon 572-1 because these UAVs are a threshold distance from the first platoon 572-1 UAVs. That is, the group module 260, using a clustering algorithm, may join different UAVs 100 on account of their proximity to one another and, in some examples, based on additional information such as UAV 100 characteristics, air traffic control data, and weather data.

Similarly, the fourth UAV 100-4, fifth UAV 100-5, and sixth UAV 100-6 may be grouped in a second platoon 572-2 because of their presence in the first corridor 574-1, similar planned path, and being within a threshold distance of one another. Still further, an eleventh UAV 100-11, twelfth UAV 100-12, and thirteenth UAV 100-13 may be grouped into a third platoon 572-3 on account of each of these being in the second air corridor 574-2, having a similar planned path, and being within a threshold distance of one another as defined by some metric included in the grouping model 254.

By comparison, a tenth UAV 100-10, may not be grouped with these UAVs for various reasons, notwithstanding being in the second air corridor 574-2. For example, the tenth UAV 100-10 may be of a different type (e.g., passenger vs. cargo) than the other UAVs 100 in the third platoon 572-3, may have dynamic ranges that do not coincide with the other UAVs 100 in the third platoon 572-3, or may be outside of a threshold distance of the UAVs 100 that make up the third platoon 572-3. While particular reference is made to particular criteria by which the tenth UAV 100-10 is not included in the third platoon 572-3, the tenth UAV 100-10 may not be included for various reasons.

In an example, the seventh UAV 100-7 may not be included in a platoon 572 for a variety of reasons. In one example, platoons 572 may be defined, at least partly, based on the air corridor in which the UAVs 100 are located. In this example, the seventh UAV 100-7 may be transitioning between air corridors 574-1 and 574-2 and, therefore, is not in a predefined air corridor. For at least this reason, the seventh UAV 100-7 may not be included in any platoon.

As described above, the air corridor that serves as a basis for forming platoons 572 may be a vertical corridor such as a third air corridor 574-3 and a fourth air corridor 574-4. For example, it may be desirable to group UAVs 100 taking off from the same location. Accordingly, an eighth UAV 100-8 and a ninth UAV 100-9 may be grouped into a fourth platoon 572-4 on account of 1) being within the third corridor 574-3, which is a vertical corridor, 2) having a similar planned path, and 3) having relative proximity to one another. Moreover, the fourteenth UAV 100-14, the fifteenth UAV 100-15, and the sixteenth UAV 100-16 may be grouped into a fifth platoon 572-5 based on 1) being within the fourth air corridor 574-4, 2) having a similar planned path, and 3) having a relative proximity one to another (as defined by the position data in respective intent messages and the grouping model 254).

Note that while particular characteristics are described as being criteria for inclusion or exclusion from a platoon 572, as described above any or multiple of the criteria mentioned above (position data, UAV characteristic data, air traffic controller connection status data, etc.) may be used to group UAVs 100 into platoons 572. That is, the group module 260 may use various multi-factorial criteria for grouping UAVs 100.

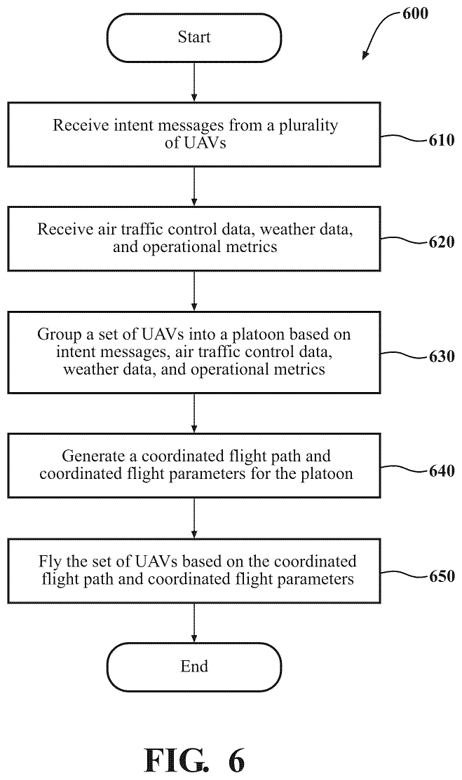

Additional aspects of forming and managing UAV platoons 572 will be discussed in relation to FIG. 6. FIG. 6 illustrates a flowchart of a method 600 that is associated with forming and managing UAV platoons 572 based on intent messages 370 shared between UAVs 100 or between UAVs 100 and a remote server 368. Method 600 will be discussed from the perspective of the UAV platoon system 146 of FIGS. 1, 2, 3 and 4. While method 600 is discussed in combination with the UAV platoon system 146, it should be appreciated that the method 600 is not limited to being implemented within the UAV platoon system 146 but is instead one example of a system that may implement the method 600.

At 610, the UAV platoon system 146, whether on a requesting UAV 100 or a remote server 368, receives intent messages 370 from a plurality of UAVs 100. As described above, the intent messages 370 may be broadcast from the UAVs 100 or received as a response to a broadcast request for such. In either case, the intent messages 370 include, among other things, an air corridor 574 and a planned path for a respective UAV 100. The intent messages 370 may be received via the associated communication systems 148 and 256.

Moreover, as described above, the intent messages 370 may include other data such as position data, UAV characteristic data, and air traffic controller connection status data. As described above, each of these pieces of data, which may be included in the packaged intent messages 370 that are shared between entities, may be the basis of a grouping of UAVs 100 into platoons 572.

At 620, additional information may be received, specifically air traffic control data, weather data, and operational metrics. That is, in addition to the information included in an intent message 370, the group module 260 may rely on information collected from other sources when determining how/whether to group UAVs 100. As a specific example, the UAV platoon system 146 may include instructions that cause the processor 256 to receive air traffic control data from an air traffic controller. That is, the UAV platoon system 146 may communicate with an air traffic control station via, for example, the communication systems 148 and 266. Through this channel, the air traffic controller may transmit certain information the group module 260 relies on when grouping UAVs. That is, the group module 260 includes instructions that cause the processor 256 to group the sets of UAVs 100 into the platoon 572 based on the air traffic control data.

The air traffic control data may be of various types. For example, the air traffic control data may indicate temporal restrictions on platooning, such as being prohibited during certain times of the day. As another example, different air corridors 574 may restrict the type of UAVs 100 permitted therein. For example, high-altitude air corridors 574 may be reserved for cargo transport, as the wind in high-altitude air corridors 574 may result in discomforting conditions for a passenger. Other air corridors 574 may be zoned for just passenger transport. In other examples, air corridors 574 may be zoned for passenger and cargo transport. The air traffic control data may transmit packets indicating these and other restrictions to the UAV platoon system 146.

As yet another example, the air traffic control data may indicate broken down, out-of-service, or malfunctioning equipment (e.g., communication equipment) that may negatively impact the safety and performance of the platoon 572. In another example, the air traffic control data may enforce certain boundaries around stationary objects. For example, the air traffic controller may prevent the formation of a platoon 572 if the platoon 572 is too close to buildings as the proximity of the buildings to the platoon 572 may negatively impact the safety of the building and the UAVs 100.

In this example, the air traffic controller may transmit this information to the UAV platoon system 146. While particular reference is made to particular air traffic control data, other air traffic control data may be shared, which the UAV platoon system 146, and more specifically, the group module 260 may rely on when grouping UAVs 100 into platoons 572.

Still at 620, the UAV platoon system 146 may include instructions that cause the processor 256 to receive weather data from a weather station, and the group module 260 may include instructions that cause the processor 256 to group UAVs 100 into a platoon 572 based on the weather data. For example, inclement weather may preclude the formation of a platoon 572 as the inclement weather may pose a significant risk to the UAVs 100 and any freight and/or passengers therein. As another example, the weather data may restrict the formation and management of platoons 572. For example, wind speeds exceeding a certain amount may limit platoons 572 to include freight cargo to ensure passenger safety and comfort.

As another example, at 620, the UAV platoon system 146 may include instructions that cause the processor 256 to group the set of UAVs 100 into platoons 572 based on operational metrics. As described above, operational metrics may reference data included in the grouping model 254 used to evaluate the information included in the intent messages 370 when grouping UAVs 100. Examples include safety metrics, energy metrics, comfort metrics, air corridor capacity metrics, and cargo metrics. Accordingly, the group module 260 may consider these operational metrics and group the UAVs 100 accordingly.

Accordingly, at 630, the group module 260 may group a set of UAVs 100 into a platoon 572 based on the air corridor 574 and planned paths in multiple intent messages 370. That is, the group module 260 receives multiple intent messages 370, each with an identified air corridor 574 and planned path for a respective UAV 100. The group module 260 then groups the UAVs 100 based on a measured similarity between the air corridors and planned paths, which similarity may be determined based on a multi-factorial clustering operation as described above. In one example, multiple UAVs 100 that are in the same air corridor and heading in the same direction over some time, for example, on the order of multiple seconds or minutes, may be grouped. That is, UAVs 100 in a platoon 572 may have a different destination. However, along the routes to these destinations, the UAVs 100 may follow similar trajectories for at least a portion of their travel time. These UAVs 100 may be grouped based on the shared similarity for when the similarities are the same (i.e., while traveling along the shared planned path). At any point when the intent message 370 information differs, for example, as different UAVs head in different directions towards their intended destination, the platoon 572 may be dissolved, or diverging UAVs 100 may be controlled/instructed to leave the platoon 572.

At 640, the flight information module 262 generates a coordinated flight path and coordinated flight patterns for the platoon 572. As described above, the coordinated flight path may indicate a sequence of waypoints that the platoon 572 will fly past along a route. The flight path may also include the clothoid curve between waypoints to provide a smooth flight path. The flight information module 262 may also generate the flight parameters (e.g., speed, deceleration/acceleration rates and thresholds, maneuver rates and thresholds) for the platoon 572 as described above.

At 650, the control module 264 may fly the set of UAVs 100 based on the coordinated flight path and coordinated flight parameters. That is, the control module 264 may establish a communication link with each UAV 100 in the platoon 572 and send control signals to the individual UAVs 100, which control signals are received by the flight systems 118 and/or automated flying modules 144 of the UAV 100 and used to control the operation of the different flight systems. Put another way, the control signals alter the operation of the various flight systems 118 such that the UAV 100 follows the coordinated flight path consistent with the coordinated flight parameters.

In another example, the control module 264 transmits the coordinated flight path and coordinated flight parameters to the UAVs 100. UAV systems such as the automated flying module 144 and various flight systems 118 control the UAV 100 along the flight path using the parameters transmitted by the control module 264. In an example depicted in FIG. 7, the transmission of the coordinated flight path and coordinated flight parameters may be via an altered intent message 370. That is, the intent message 370 may include control signals that control the flight systems and other systems of the UAV to perform automated flight in a particular fashion. In this example, by altering the intent messages 370, the control module 264 alters the instruction set that defines the automated flight so that the UAV 100 follows a coordinated flight path using parameters established by the flight information module 262.

FIG. 7 is a pictorial diagram of the UAV platoon system 146 forming and managing a platoon 572 of UAVs 100. As described above, the UAV platoon system 146 may base UAV grouping on various pieces of data. For example, as depicted in FIG. 7, the UAV platoon system 146 may receive air traffic control data from an air traffic controller 776, weather data from a weather station 778, and intent messages 370 from a plurality of UAVs 100-1, 100-2, 100-3, and 100-4, which UAVs 100-1, 100-2, 100-3, and 100-4 are candidates to be formed into a platoon 572.

The group module 260 determines if there are UAVs 100 in a particular air corridor 574. This may be determined based on the intent messages 370 received from the UAVs 100. That is, UAV intent messages 370 may indicate the air corridor 574 where the respective UAV 100 is located. As such, the group module 260 may extract this information to determine whether UAVs 100 are found in a particular air corridor 574.

If not, the group module 260 continues to monitor for multiple UAVs 100 in the particular air corridor 574. If there are multiple UAVs 100 in an air corridor 574, the group module 260 considers certain operational metrics 780 when deciding 1) whether to group UAVs 100 into a platoon 572 and 2) which UAVs 100 to group into the platoon 572. As described above, example operational metrics 780 include safety metrics (e.g., whether formation of a platoon 572 under the current environmental conditions is safe to cargo and/or passengers), energy metrics (e.g., whether the formation of a platoon 572 is energy efficient), air corridor capacity metrics (e.g., whether the air corridor 572 can support additional UAVs 100 and/or a platoon 572 of UAVs 100), and a cargo metrics (e.g., whether a certain type of cargo is permitted and whether conditions are suitable for a particular type of cargo). Examples of each are provided herein.

As an example of a safety metric, the group module 260, considering weather conditions, data included in an intent message 370, and air traffic controller data may determine whether it is safe to form a platoon 572. For example, under certain wind conditions, it may be permissible to allow freight-based UAV platoons 572 while preventing passenger platoons 572, as the wind conditions may be unsafe for passengers. The safety metrics depicted in FIG. 7 include the weights, algorithms, biases, criteria, etc., by which various conditions are evaluated to determine whether platooning flight is safe. As described above, these safety metrics may be included in the grouping model 254.

As another example, while platoon flying may reduce energy consumption in some aspects, UAVs 100 may expend more energy adjusting speed and/or elevation to maintain a flight formation with other UAVs 100. Accordingly, there is a tradeoff between energy conserved by flying in a platoon 572 and energy expended by flying in a platoon 572. The group module 260 may consider this trade-off when determining whether to form a platoon 572. As such, the energy metrics depicted in FIG. 7 include the weights, algorithms, biases, criteria, etc., by which various conditions are evaluated to determine whether platooning flight is energy efficient. As described above, these energy metrics may be included in the grouping model 254.

As another example, as described above, air corridors 574 may have a certain capacity that, when exceeded, poses an undesirable level of risk to the UAVs 100, freight, and passengers. The capacity metrics depicted in FIG. 7 include the weights, algorithms, biases, criteria, etc., by which various conditions are evaluated to determine whether platooning flight poses a risk of overwhelming the capacity of an air corridor 574. As described above, these capacity metrics may be included in the grouping model 254.

As another example, cargo (e.g., freight or passengers) metrics may be considered when determining whether to group UAVs 100 into a platoon 572. For example, during platoon flight, there may be more positional/movement adjustments for a particular UAV 100 than when flying solo. These periodic adjustments may prove uncomfortable for a passenger. The cargo metrics depicted in FIG. 7 include the weights, algorithms, biases, criteria, etc., by which various conditions are evaluated to determine whether platooning flight should be facilitated based on the cargo of the UAVs 100. As described above, these cargo metrics may be included in the grouping model 254.

Considering the various pieces of data (i.e., intent message 370 data, air traffic control data, and weather data) in light of the described operational metrics 780, the group module 260 may initiate platoon formation. Otherwise, the group module 260 may return to monitoring for multiple UAVs 100 in an air corridor 574.

In an example, the flight information module 262 may then generate the coordinated flight path and the coordinated flight parameters for the platoon 572. That is, the flight information module 262 may determine the planned path and certain parameters (e.g., speed, deceleration and acceleration ranges, maneuver thresholds, etc.) for the platoon 572. In some examples, the flight information module 262 includes instructions that cause the processor 256 to generate the coordinated flight path and coordinated flight parameters for the platoon 572 based on the operational metrics 780. As a specific example, the flight information module 262 may be a model predictive controller (MPC) that includes a cost function and predictive model that optimizes the coordinated flight path and coordinated flight parameters based on the operational metrics 780.

That is, compliance with certain operational metrics 780 may have an associated cost. For example, fewer larger platoons 572 may be safer than a greater amount of smaller platoons 572. However, larger platoons 572 may be less energy efficient. As another example, energy efficiency may dictate that a platoon 572 flies quicker, whereas safety may dictate a slower speed for a platoon 572. As yet another example, to ensure safety, it may be desirable to have the UAVs 100 maintain a predetermined distance between one another. However, doing so may reduce the energy efficiency that results from flying in a formation.

Accordingly, the MPC flight information module 262 may simultaneously optimize the flight path and flight parameters based on the different or other operational metrics 780. Put another way, there may be multiple flight paths and multiple flight parameters that could be used during platooned flights, each with different costs (e.g., energy consumption, passenger dissatisfaction, etc.). The flight information module 262 may evaluate these different costs simultaneously to select a desired flight path and parameters predicted to satisfy the operational metrics 780. In an example, the flight path and flight parameters that optimize the operation metrics 780 may be selected and transmitted to the control module 264 for transmission/control of the platoon UAVs 100. As such, the operational metrics 780 1) serve as baseline metrics that define the grouping of UAVs 100 into a platoon 572 and 2) are optimized to ensure an efficient, safe, and reliable platoon 572 flight.

As described above, the control module 264 then controls the components and flies the UAVs 100 in the platoon 572. Specifically, the control module 264 may generate updated intent messages 370 that include content (i.e., updated position data, updated planned path data, updated dynamics data, etc.). The updated intent messages 370 are then transmitted to the different UAVs 100. In one example, this may be done iteratively through the UAVs 100 in the platoon 572. That is, the transmission of coordinated flight paths and coordinated flight parameters may first be sent to a first UAV 100-1 and updated based on the intent message from the first UAV 100-1 and subsequently sent to the second UAV 100-2. This may be performed sequentially until all UAVs 100 in the platoon 572 have received and processed the updated flight controls.

FIG. 1 will now be discussed in full detail as an example environment within which the system and methods disclosed herein may operate. In some instances, the UAV 100 is configured to switch selectively between an autonomous mode, one or more semi-autonomous modes, and/or a manual mode. “Manual mode” means that all of or a majority of the control and/or maneuvering of the UAV 100 is performed according to inputs received via manual human-machine interfaces (HMIs) (e.g., control sticks, pedals, directional pads, buttons, etc.) of a UAV 100 as manipulated by a user (e.g., a pilot).

In one or more arrangements, the UAV 100 implements some level of automation in order to operate autonomously or semi-autonomously. In general, autonomous control generally involves control and/or maneuvering of the UAV 100 along a travel route via a computing system to control the UAV 100 with minimal or no input from a pilot. By contrast, the semi-autonomous mode provides a portion of the control and/or maneuvering of the UAV 100 via a computing system along a travel route with a pilot (not on the UAV 100) providing at least a portion of the control and/or maneuvering of the UAV 100.

With continued reference to the various components illustrated in FIG. 1, the UAV 100 includes one or more processors 102. In one or more arrangements, the processor(s) 102 can be a primary/centralized processor of the UAV 100 or may be representative of many distributed processing units. For instance, the processor(s) 102 can be an electronic control unit (ECU). Alternatively, or additionally, the processors include a central processing unit (CPU), a graphics processing unit (GPU), an ASIC, a microcontroller, a system on a chip (SoC), and/or other electronic processing units that support the operation of the UAV 100.

The UAV 100 can include one or more data stores 130 for storing one or more types of data. The data store 130 can be comprised of volatile and/or non-volatile memory. Examples of memory that may form the data store 130 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, solid-state drivers (SSDs), and/or other non-transitory electronic storage medium. In one configuration, the data store 130 is a component of the processor(s) 102. In general, the data store 130 is operatively connected to the processor(s) 102 for use thereby. The term “operatively connected,” as used throughout this description, can include direct or indirect connections, including connections without direct physical contact.

In one or more arrangements, the one or more data stores 130 include various data elements to support functions of the UAV 100, such as semi-autonomous and/or autonomous functions. Thus, the data store 130 may store map data 132 and/or sensor data 138. The map data 132 includes, in at least one approach, maps of one or more geographic areas. In some instances, the map data 132 can include information about air corridors 574, structures, features, and/or landmarks in the one or more geographic areas. The map data 132 may be characterized, in at least one approach, as a high-definition (HD) map that provides information for autonomous and/or semi-autonomous functions.

In one or more arrangements, the map data 132 can include one or more terrain maps 134. The terrain map(s) 134 can include information about the ground, terrain, surfaces, topology, and/or other features of one or more geographic areas. The terrain map(s) 134 can include elevation data in the one or more geographic areas. In one or more arrangements, the map data 132 includes one or more static obstacle maps 136. The static obstacle map(s) 136 can include information about one or more static obstacles located within one or more geographic areas. A “static obstacle” is a physical object whose position and general attributes do not substantially change over a period of time. Examples of static obstacles include trees and buildings.

The sensor data 138 is data provided from one or more sensors of the sensor system 104. Thus, the sensor data 138 may include observations of a surrounding environment of the UAV 100 and/or information about the UAV 100 itself. In some instances, one or more data stores 130 located onboard the UAV 100 store at least a portion of the map data 132 and/or the sensor data 138. Alternatively, or in addition, at least a portion of the map data 132 and/or the sensor data 138 can be located in one or more data stores 130 that are located remotely from the UAV 100.

As noted above, the UAV 100 can include the sensor system 104. The sensor system 104 can include one or more sensors. As described herein, “sensor” means an electronic and/or mechanical device that generates an output (e.g., an electric signal) responsive to a physical phenomenon, such as electromagnetic radiation (EMR), sound, etc. The sensor system 104 and/or the one or more sensors can be operatively connected to the processor(s) 102, the data store(s) 130, and/or another element of the UAV 100.

Various examples of different types of sensors will be described herein. However, it will be understood that the embodiments are not limited to the particular sensors described. In various configurations, the sensor system 104 includes one or more aircraft sensors 106 and/or one or more environment sensors 108. The aircraft sensor(s) 106 function to sense information about the UAV 100 itself. In one or more arrangements, the aircraft sensor(s) 106 include one or more accelerometers, one or more altimeters, one or more gyroscopes, an inertial measurement unit (IMU), a dead-reckoning system, a global navigation satellite system (GNSS), a global positioning system (GPS), an air speed sensor and/or other sensors for monitoring aspects about the UAV 100.

As noted, the sensor system 104 can include one or more environment sensors 108 that sense a surrounding environment (e.g., external) of the UAV 100. For example, the one or more environment sensors 108 sense objects the surrounding environment of the UAV 100. Such obstacles may be stationary objects and/or dynamic objects. Various examples of sensors of the sensor system 104 will be described herein. The example sensors may be part of the one or more environment sensors 108 and/or the one or more aircraft sensors 106. However, it will be understood that the embodiments are not limited to the particular sensors described. As an example, in one or more arrangements, the sensor system 104 includes one or more radar sensors 110, one or more LIDAR sensors 112, one or more sonar sensors 114 (e.g., ultrasonic sensors), and/or one or more cameras 116 (e.g., monocular, stereoscopic, RGB, infrared, etc.).

Continuing with the discussion of elements from FIG. 1, the UAV 100 can include an input system 140. The input system 140 generally encompasses one or more devices that enable the acquisition of information by a machine from an outside source, such as an operator. The input system 140 can receive an input from a UAV passenger (e.g., a driver/operator and/or a passenger). Additionally, in at least one configuration, the UAV 100 includes an output system 142. The output system 142 includes, for example, one or more devices that enable information/data to be provided to external targets (e.g., a person, a UAV passenger, another UAV, another electronic device, etc.).

Furthermore, the UAV 100 includes, in various arrangements, one or more flight systems 118. Various examples of the one or more flight systems 118 are shown in FIG. 1. However, the UAV 100 can include a different arrangement of flight systems. It should be appreciated that although particular flight systems are separately defined, each or any of the systems or portions thereof may be otherwise combined or segregated via hardware and/or software within the UAV 100. As illustrated, the UAV 100 includes a propulsion system 120, a steering system 122, a throttle system 124, and a navigation system 126.

The navigation system 126 can include one or more devices, applications, and/or combinations thereof to determine the geographic location of the UAV 100 and/or to determine a travel route for the UAV 100. The navigation system 126 can include one or more mapping applications to determine a travel route for the UAV 100 according to, for example, the map data 132. The navigation system 126 may include or at least provide connection to a global positioning system, a local positioning system or a geolocation system.

In one or more configurations, the flight systems 118 function cooperatively with other components of the UAV 100. For example, the processor(s) 102, the UAV platoon system 146, and/or automated flying module(s) 144 can be operatively connected to communicate with the various flight systems 118 and/or individual components thereof. For example, the processor(s) 102 and/or the automated flying module(s) 144 can be in communication to send and/or receive information from the various flight systems 118 to control the navigation and/or maneuvering of the UAV 100. The processor(s) 102, the UAV platoon system 146, and/or the automated flying module(s) 144 may control some or all of these flight systems 118.

For example, when operating in the autonomous mode, the processor(s) 102, the UAV platoon system 146, and/or the automated flying module(s) 144 control the heading, elevation, and speed of the UAV 100. The processor(s) 102, the UAV platoon system 146, and/or the automated flying module(s) 144 cause the UAV 100 to accelerate (e.g., by increasing the supply of energy/fuel provided to a motor), decelerate, and/or change direction and/or elevation. As used herein, “cause” or “causing” means to make, force, compel, direct, command, instruct, and/or enable an event or action to occur either in a direct or indirect manner.

As shown, the UAV 100 includes one or more actuators 128 in at least one configuration. The actuators 128 are, for example, elements operable to move and/or control a mechanism, such as one or more of the flight systems 118 or components thereof responsive to electronic signals or other inputs from the processor(s) 102 and/or the automated flying module(s) 144. The one or more actuators 128 may include motors, pneumatic actuators, hydraulic pistons, relays, solenoids, piezoelectric actuators, and/or another form of actuator that generates the desired control.

As described previously, the UAV 100 can include one or more modules, at least some of which are described herein. In at least one arrangement, the modules are implemented as non-transitory computer-readable instructions that, when executed by the processor 102, implement one or more of the various functions described herein. In various arrangements, one or more of the modules are a component of the processor(s) 102, or one or more of the modules are executed on and/or distributed among other processing systems to which the processor(s) 102 is operatively connected. Alternatively, or in addition, the one or more modules are implemented, at least partially, within hardware. For example, the one or more modules may be comprised of a combination of logic gates (e.g., metal-oxide-semiconductor field-effect transistors (MOSFETs)) arranged to achieve the described functions, an application-specific integrated circuit (ASIC), programmable logic array (PLA), field-programmable gate array (FPGA), and/or another electronic hardware-based implementation to implement the described functions. Further, in one or more arrangements, one or more of the modules can be distributed among a plurality of the modules described herein. In one or more arrangements, two or more of the modules described herein can be combined into a single module.

Furthermore, the UAV 100 may include one or more automated flying modules 144. The automated flying module(s) 144, in at least one approach, receive data from the sensor system 104 and/or other systems associated with the UAV 100. In one or more arrangements, the automated flying module(s) 144 use such data to perceive a surrounding environment of the UAV 100. The automated flying module(s) 144 determine a position of the UAV 100 in the surrounding environment and map aspects of the surrounding environment. For example, the automated flying module(s) 144 determines the location of obstacles or other environmental features including trees, buildings, neighboring UAVs, etc.

The automated flying module(s) 144 either independently or in combination with the UAV platoon system 146 can be configured to determine travel path(s), current autonomous maneuvers for the UAV 100, future autonomous maneuvers and/or modifications to current autonomous maneuvers based on data acquired by the sensor system 104 and/or another source. In general, the automated flying module(s) 144 functions to, for example, implement different levels of automation, including semi-autonomous functions, and fully autonomous functions, as previously described.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-7, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. The systems, components and/or processes also can be embedded in a computer-readable storage, such as a computer program product or other data program storage device, readable by a machine, tangibly embodying a program of instructions executable by the machine to perform methods and processes described herein. These elements also can be embedded in an application product which comprises the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. A non-exhaustive list of the computer-readable storage medium can include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or a combination of the foregoing. In the context of this document, a computer-readable storage medium is, for example, a tangible medium that stores a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory storing machine-readable instructions that, when executed by the processor, cause the processor to:
receive, from a plurality of unmanned aerial vehicles (UAVs), intent messages comprising an air corridor and planned path for a respective UAV;
group, based on the air corridor and the planned path in multiple intent messages, a set of UAVs into a platoon;
generate a coordinated flight path and coordinated flight parameters for the platoon; and
fly the set of UAVs based on the coordinated flight path and the coordinated flight parameters.

2. The system of claim 1, wherein the machine-readable instruction that causes the processor to fly the set of UAVs based on the coordinated flight path and the coordinated flight parameters comprises a machine-readable instruction that causes the processor to transmit the coordinated flight path and the coordinated flight parameters to the set of UAVs to exhibit coordinated flight.

3. The system of claim 1, wherein:
an intent message further comprises at least one of:
position data for the respective UAV;
UAV characteristic data for the respective UAV; and
air traffic controller connection status data for the respective UAV; and
wherein the machine-readable instruction that causes the processor to group the set of UAVs comprises a machine-readable instruction that causes the processor to group the set of UAVs based on at least one of the position data, the UAV characteristic data, or the air traffic controller connection status data.

4. The system of claim 1, wherein the machine-readable instruction that causes the processor to fly the set of UAVs based on the coordinated flight path and the coordinated flight parameters further comprises a machine-readable instruction that causes the processor to control at least one of a flight plan, a flight parameter, a flying formation, a flight speed, a duration of the platoon, an acceleration range, a deceleration range, or a maneuver execution rate.

5. The system of claim 1, wherein the machine-readable instructions that cause the processor to generate the coordinated flight path and the coordinated flight parameters for the platoon and fly the set of UAVs based on the coordinated flight path and the coordinated flight parameters are executed iteratively through a set of following UAVs.

6. The system of claim 1, wherein:
the machine-readable instruction that causes the processor to group the set of UAVs into the platoon comprises a machine-readable instruction that causes the processor to group the set of UAVs into the platoon based on an operational metric; and
the machine-readable instruction that causes the processor to generate the coordinated flight path and the coordinated flight parameters for the platoon comprises a machine-readable instruction that causes the processor to generate the coordinated flight path and the coordinated flight parameters for the platoon based on the operational metric.

7. The system of claim 6, wherein the machine-readable instruction that causes the processor to group the set of UAVs into the platoon based on the operational metric comprises a machine-readable instruction that causes the processor to group the set of UAVs based on at least one of:
a safety metric;
an energy metric;
an air corridor capacity metric; and
a cargo metric.

8. The system of claim 1, wherein:
the machine-readable instructions further comprise a machine-readable instruction that, when executed by the processor, causes the processor to receive air traffic control data from an air traffic controller; and
the machine-readable instruction that causes the processor to group the set of UAVs into the platoon comprises a machine-readable instruction that causes the processor to group the set of UAVs into the platoon based on the air traffic control data.

9. The system of claim 1, wherein:
the machine-readable instructions further comprise a machine-readable instruction that, when executed by the processor, causes the processor to receive weather data from a weather station; and
the machine-readable instruction that causes the processor to group the set of UAVs into the platoon comprises a machine-readable instruction that causes the processor to group the set of UAVs into the platoon based on the weather data.

10. A non-transitory machine-readable medium comprising instructions that, when executed by a processor, cause the processor to:
receive, from a plurality of unmanned aerial vehicles (UAVs), intent messages comprising an air corridor and planned path for a respective UAV;
group, based on the air corridor and the planned path in multiple intent messages, a set of UAVs into a platoon;
generate a coordinated flight path and coordinated flight parameters for the platoon; and
fly the set of UAVs based on the coordinated flight path and the coordinated flight parameters.

11. The non-transitory machine-readable medium of claim 10, wherein the instruction that causes the processor to fly the set of UAVs based on the coordinated flight path and the coordinated flight parameters comprises an instruction that causes the processor to transmit the coordinated flight path and the coordinated flight parameters to the set of UAVs to exhibit coordinated flight.

12. The non-transitory machine-readable medium of claim 10, wherein:
an intent message further comprises at least one of:
position data for the respective UAV;
UAV characteristic data for the respective UAV; and
air traffic controller connection status data for the respective UAV; and
wherein the instruction that causes the processor to group the set of UAVs comprises an instruction that causes the processor to group the set of UAVs on at least one of the position data, the UAV characteristic data, or the air traffic controller connection status data.

13. The non-transitory machine-readable medium of claim 10, wherein:
the instruction that causes the processor to group the set of UAVs into the platoon comprises an instruction that causes the processor to group the set of UAVs into the platoon based on an operational metric; and
the instruction that causes the processor to generate the coordinated flight path and the coordinated flight parameters for the platoon comprises an instruction that causes the processor to generate the coordinated flight path and the coordinated flight parameters for the platoon based on the operational metric.

14. The non-transitory machine-readable medium of claim 10, wherein:
the machine-readable medium further comprises an instruction that, when executed by the processor, causes the processor to receive at least one of air traffic control data or weather data; and
the instruction that causes the processor to group the set of UAVs into the platoon comprises an instruction that causes the processor to group the set of UAVs into the platoon based on at least one of the air traffic control data or the weather data.

15. A method, comprising:
receiving, from a plurality of unmanned aerial vehicles (UAVs), intent messages comprising an air corridor and planned path for a respective UAV;
grouping, based on the air corridor and the planned path in multiple intent messages, a set of UAVs into a platoon;
generating a coordinated flight path and coordinated flight parameters for the platoon; and
flying the set of UAVs based on the coordinated flight path and the coordinated flight parameters.

16. The method of claim 15, wherein flying the set of UAVs based on the coordinated flight path and the coordinated flight parameters comprises transmitting the coordinated flight path and the coordinated flight parameters to the set of UAVs to exhibit coordinated flight.

17. The method of claim 15, wherein flying the set of UAVs based on the coordinated flight path and the coordinated flight parameters further comprises controlling at least one of a flight plan, a flight parameter, a flying formation, a flight speed, a duration of the platoon, an acceleration range, a deceleration range, or a maneuver execution rate.

18. The method of claim 15, wherein generating the coordinated flight path and the coordinated flight parameters for the platoon and flying the set of UAVs based on the coordinated flight path and the coordinated flight parameters are executed iteratively through a set of following UAVs.

19. The method of claim 15, wherein:
grouping the set of UAVs into the platoon comprises grouping the set of UAVs into the platoon based on an operational metric; and
generating the coordinated flight path and the coordinated flight parameters for the platoon comprises generating the coordinated flight path and the coordinated flight parameters for the platoon based on the operational metric.

20. The method of claim 15, wherein:
the method further comprises receiving at least one of air traffic control data or weather data; and
grouping the set of UAVs into the platoon comprises grouping the set of UAVs into the platoon based on at least one of the air traffic control data or the weather data.
